(19) United States
(12) Patent Application Publication
(10) Pub. No.: US 2006/0202546 A1
(43) Pub. Date: Sep. 14, 2006

(54) Multipurpose utility trailer

(76) Inventors: Christopher Baker, Clintonville, WI (US); Donald Otte, New Berlin, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 11/369,710

(22) Filed: Mar. 7, 2006

Related U.S. Application Data
(60) Provisional application No. 60/661,585, filed on Mar. 14, 2005.

(51) Int. Cl. B60P 1/28

(52) U.S. Cl. 298/18

(57) ABSTRACT

A multipurpose utility trailer is provided for transporting materials and equipment. The utility trailer has a wheeled elongated frame and a platform is positioned at the rear end of the frame for supporting and transporting equipment. A dump box is positioned at the front end of the frame and is pivotably attached to the frame such that it is movable between a lowered position for containing and transporting materials and a raised position for discharging materials to one side of the frame. A hydraulic mechanism is provided to pivot the dump box between lowered and raised positions. In one embodiment, the dump box includes a plurality of side portions and a bottom portion. One of the side portions is pivotably attached to the dump box and pivotable between a closed position to retain the materials in the dump box and an open position to allow for discharge of the materials to one side of the frame.

### FIELD OF THE INVENTION

The present invention relates to utility trailers used in, for example, the construction industry. More specifically, the present invention relates to a multipurpose utility trailer for transporting heavy equipment and for loading, transporting and discharging construction and other miscellaneous materials.

### BACKGROUND OF THE INVENTION

Wheeled, flatbed trailers have been used in the construction industry for many years to carry and transport construction materials and equipment from place to place. Wheeled, dump trailers having dump boxes for loading, transporting and dumping construction and other miscellaneous materials have also been used for many years. Known arrangements for such trailers typically include a dump box having vertical side walls and a bottom for containing the materials. A hydraulic lift mechanism is often arranged to tilt the dump box towards the rear of the trailer to discharge the materials contained in the dump box. The aforementioned flatbed trailers and dump trailers typically include a wheeled frame that is attached by a tongue and hitch arrangement to a vehicle, such as a tractor or truck.

By the present invention, it is recognized as desirable to provide a multipurpose utility trailer that is adapted to carry heavy and light construction equipment, as well as construction and other miscellaneous materials such as, for example, aggregate, concrete, and other debris. It is further recognized as desirable to provide such a trailer that is modular and adaptable to a variety of different uses. In addition, it is desirable to provide such a trailer that provides the necessary structural rigidity and support when heavy construction materials are contained within the dump box, and when heavy construction equipment is carried on the flatbed.

### SUMMARY OF THE INVENTION

The present invention provides such an improved multipurpose utility trailer that is suitable for use in the light and heavy construction industries. The trailer is arranged to safely transport both heavy and light construction equipment, and to safely load, transport and discharge construction and other miscellaneous materials related to the construction industry.

In the embodiment shown and described herein, the multipurpose utility trailer includes an elongated, wheeled frame having front and rear ends and opposing elongated side members. The rear end of the frame carries a platform or flatbed for supporting and transporting construction equipment, such as front end loaders, all-terrain vehicles, and other heavy construction equipment. The front end of the frame has a dump box that is pivotably coupled to the frame and movable between a lowered position for containing and transporting materials and a raised position for discharging the materials to one side of the frame. The dump box is designed to safely contain, transport and discharge heavy materials, such as large pieces of concrete, boulders or other construction materials. One of the side portions of the dump box is pivotably attached to the dump box and, as such, is pivotable between a lowered position to retain the materials in the dump box and a raised position to allow for discharge of the materials to one side of the elongated frame.

A hydraulic lift system is arranged beneath the dump box to lower and raise the dump box between lowered and raised positions. In the lowered position, the materials are safely contained within the dump box. In the raised position, the materials are discharged to one side of the frame. Advantageously, the side portions of the dump box are removably coupled to the bottom portion. In the arrangement shown, the bottom portion includes a series of slots that are sized to receive a series of vertical joists that extend from each of the side portions.

A plurality of selectively movable stands are provided on the underside of the front end of the trailer frame. The stands are preferably positioned on either side of the dump box to provide the necessary strength and support when heavy materials are contained within the dump box.

### BRIEF DESCRIPTION OF THE DRAWINGS

Preferred embodiments of the best mode of carrying out the present invention are illustrated in the attached drawings, wherein:

FIG. 1 is a perspective view of a multipurpose utility trailer;

FIG. 2 is a perspective view of the trailer of FIG. 1 discharging materials to a side of the trailer;

FIG. 3 is a side view of the trailer;

FIGS. 4-6 are side views of loading ramps on the trailer;

FIGS. 7 and 8 are side views of stands for supporting the trailer;

FIG. 9 is an exploded view of the dump box having removable side portions;

FIG. 10 is a detailed view of a corner portion of the dump box; and

FIG. 11 is a detailed view of the hydraulic lift mechanism for the dump box.

### DETAILED DESCRIPTION OF THE PREFERRED EMBODIMENTS

In the preferred embodiment of the present invention described in detail below, a multipurpose utility trailer for transporting materials and equipment is provided. It should be understood that the drawings and specification are to be considered an exemplification of the principles of the invention, which is more particularly defined in the appended claims.

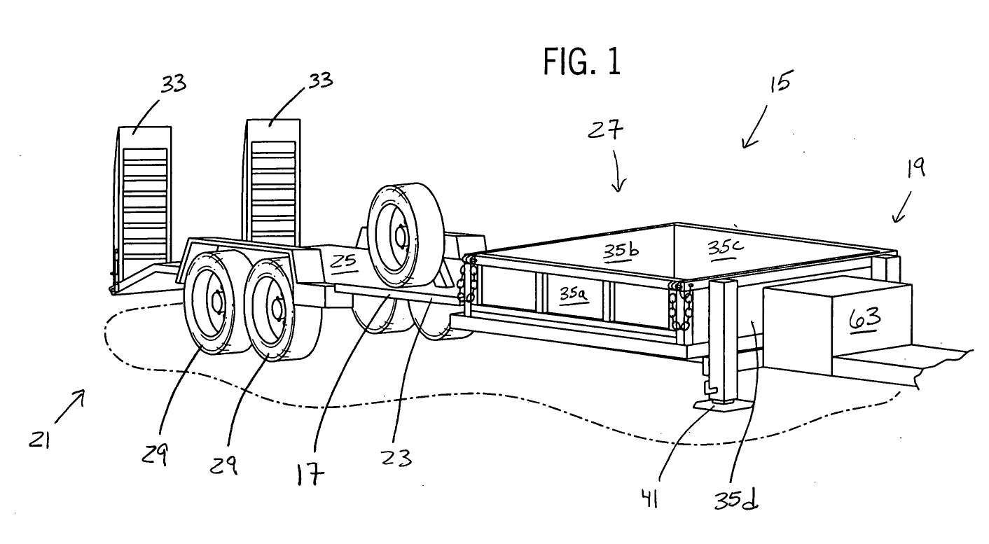

As shown in FIG. 1, the multipurpose utility trailer 15 includes an elongated frame 17 having front 19 and rear 21 ends and opposing side members 23. The rear end 21 of the frame 17 includes a platform or flatbed 25 for supporting and transporting light and heavy construction equipment. The front end 19 of the elongated frame 17 has a dump box 27 for containing, transporting and discharging materials to one side of the trailer frame 17.

The elongated frame 17 is supported by a set of wheels 29 positioned along the rear end 21 of the frame. It is recognized however that a variety of wheel arrangements may be utilized within the scope of the invention. A tongue 31 extends from the front end 19 of the frame 17 to hitch the frame 17 to a truck or other motor vehicle for trailering the utility trailer 15. The rear end 21 of the frame 17 includes a pair of ramps 33 that are shown in a raised elevated position in FIG. 1.

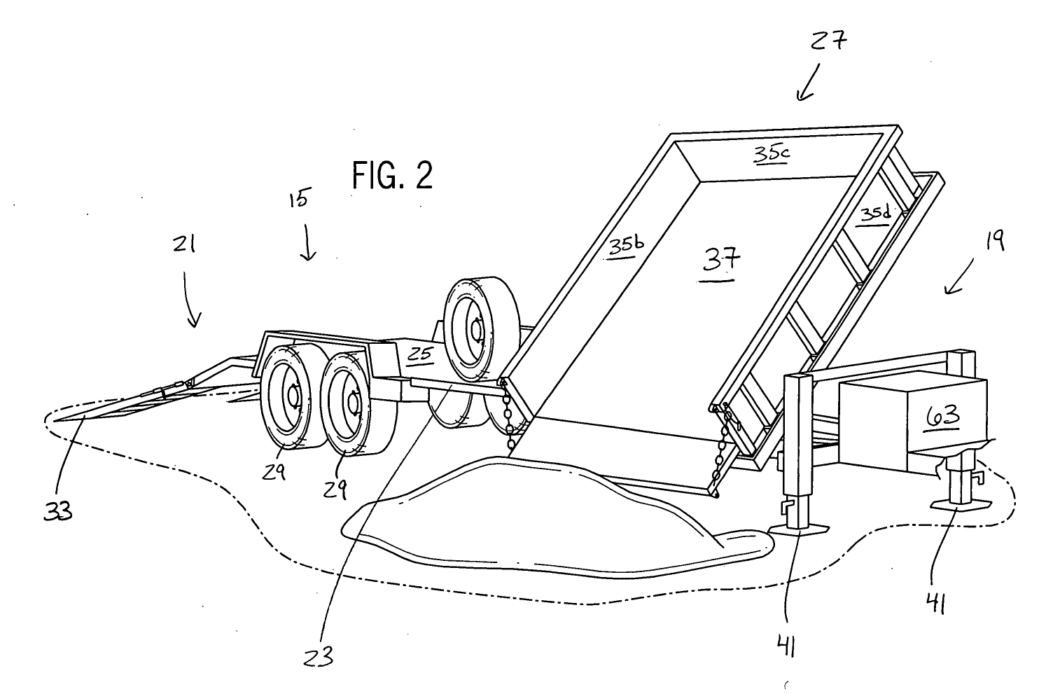

Referring to FIG. 2, the dump box 27 includes four side portions 35a-d which extend upwardly from a bottom portion 37 to define the dump box 27. One of the side portions 35a is pivotably attached to the dump box 27 and is pivotable between a closed position to retain the materials in the dump box 27 (shown in FIG. 1) and an open position to allow for discharge of the materials to one side of the frame 17 (shown in FIG. 2).

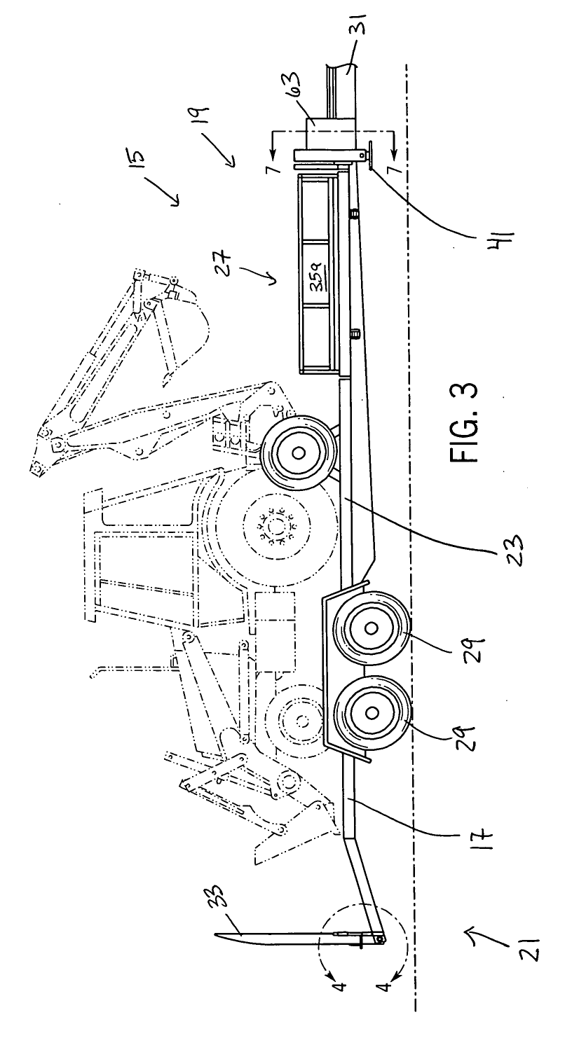

In FIG. 2, the ramps 33 are shown in the lowered position for boarding of the heavy or light construction equipment. Once the heavy or light construction equipment is boarded onto the flatbed 25, the ramps 33 are elevated into the raised position (shown in FIGS. 2 and 3).

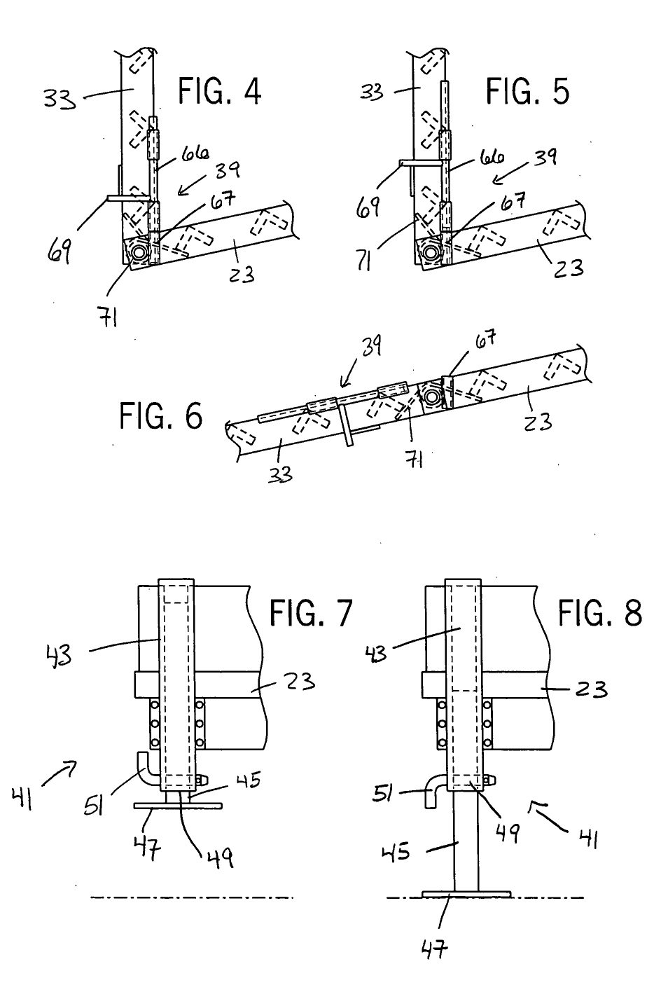

Referring to FIGS. 4-6, the rear ramps 33 are retained in the respective raised and lowered position by a locking member 39. In the embodiment shown, the locking member 39 comprises a rod 66 that extends into a sleeve 67 arranged on at least one of the side members 23 when the rear ramps are in the raised position. As such, the locking member 39 locks the rear ramps 33 in a raised position, shown in FIG. 1. When it is necessary to move the ramps 33 into a lowered position, shown in FIG. 2, a handle 69 extending from the rod 66 is manually grasped and the rod 66 is removed from the sleeve 67. Thereafter, the ramps 33 are fee to be manually positioned between the raised and lowered positions. A resilient coil 71 biases the rear ramps 33 into the raised position. The coil 71 therefore reduces the amount of force necessary to raise the rear ramps 33.

Referring to FIG. 2, the front end 19 of the elongated frame 17 includes a pair of stands 41 that are selectively positionable into either raised or lowered positions. In FIG. 2, the stands 41 are shown in a lowered position and, as such, provide support for the weight of materials contained within the dump box 27. In FIG. 3, the stands 41 are shown in the raised position and, as such, allow for transport of the trailer 15 from place to place. Referring to FIGS. 7 and 8, the stand 41 includes a sleeve 43 that receives a telescoping member 45 having a platform 47 at its lower end. The sleeve 43 and telescoping member 45 each have a series of through holes (shown in phantom) 49 which, when aligned properly, allow a pin 51 to pass therethrough. As such, the telescoping member 45 may be positioned at various heights including a retracted, raised height (FIG. 7) and an extended, lowered height (FIG. 8).

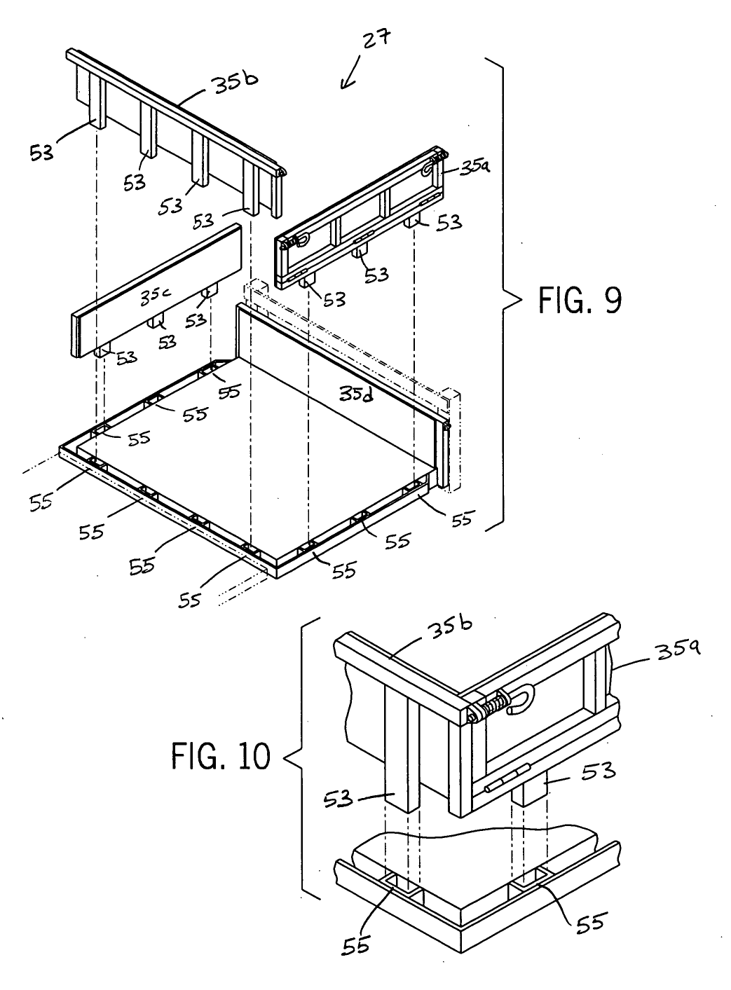

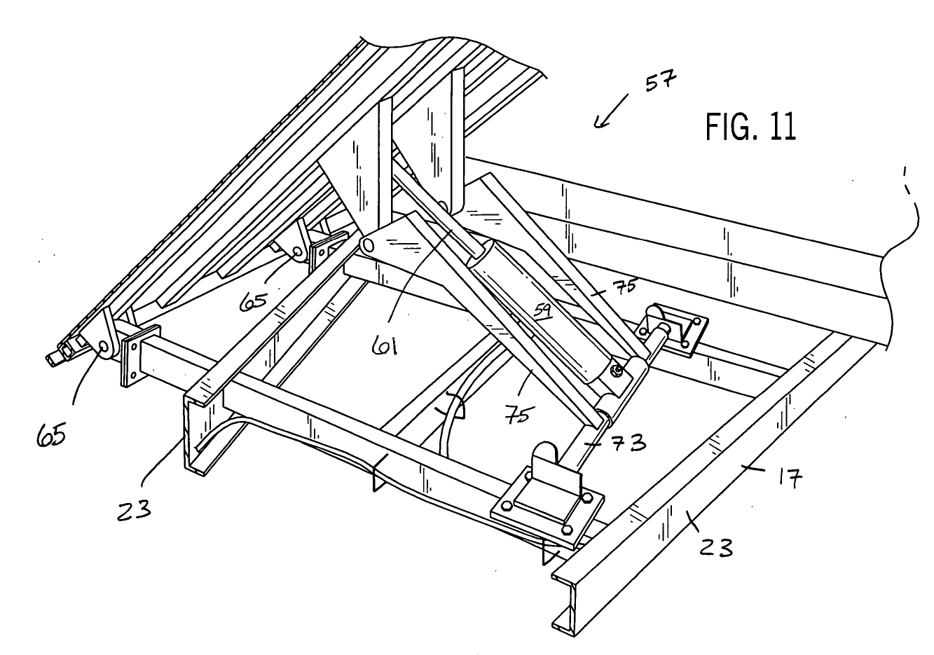

Referring now to FIGS. 9 and 10, the side portions 35a-c are removably attached to the bottom portion 37 of the dump box 27. More specifically, each side portion 35a-c includes a series of vertical joists 53 that are received within a series of slots 55 on the bottom portion 37. The slots 55 and joists 53 are commonly spaced along the respective bottom portion 37 and side portions 35a-c, such that the side portions 35a-c are easily installed and uninstalled to form the dump box 27.

Referring now to FIGS. 1, 2 and 11, the dump box is selectively movable between a lowered position (FIG. 1) and a raised position (FIG. 2) by a hydraulic lift mechanism 57. The hydraulic lift mechanism 57 includes a hydraulic cylinder 59 and rod 61 that are hydraulically controlled by a control box 63, shown in FIGS. 1 and 2. By means of the control box 63, the rod 61 is hydraulically positioned into and out of an extended position to raise and lower the dump box 27 to one side of the trailer frame 17. As shown in FIG. 11, the dump box 27 is pivotably attached at pivot points 65 along the side of the trailer frame 17. In the particular arrangement show, the hydraulic cylinder 59 is pivotably attached to a crossbar 73 which in turn is coupled to the trailer frame 17. Opposing, pivotable guide arms 75 provide further structural integrity to the hydraulic lift mechanism 57.

While this invention is susceptible to embodiments in many different forms, the drawings and specification described in detail a preferred embodiment of the invention. They are not intended to limit the broad aspects of the invention to the embodiment illustrated.

1. A multi-purpose utility trailer for transporting materials and equipment, the utility trailer comprising:
a wheeled elongated frame having front and rear ends and opposing elongated side members;
a platform positioned at the rear end of the frame for supporting and transporting equipment;
a dump box positioned at the front end of the frame; the dump box pivotably coupled to the frame and moveable between a lowered position for containing and transporting materials and a raised position for discharging materials to one side of the frame;
means for pivoting the dump box between the lowered and raised positions; and
the dump box comprising a plurality of side portions and a bottom portion, one of the side portions being pivotably attached to the dump box and pivotable between a closed position to retain the materials in the dump box and an open position to allow for discharge of the materials to the one side of the frame;
wherein at least one of the side portions are removably coupled to the bottom portion.

2. The utility trailer of claim 1, wherein the at least one side portion comprises a plurality of joists that are received in a corresponding plurality slots provided on the frame to removably couple the side portions to the bottom portion.

3. The utility trailer of claim 2, wherein the dump box comprises four side portions and three of the side portions comprise a plurality of joists that are received in a corresponding plurality of slots provided on the frame to removably couple the side portions to the bottom portion.

4. The utility trailer of claim 1, further comprising a pair of stands positioned at the front end and selectively positionable into either a raised position during trailer transport or a lowered position to support the frame and the materials and equipment transported thereby.

5. The utility trailer of claim 4, wherein each stand further comprises a telescoping member having a platform at its lower end.

6. The utility trailer of claim 5, wherein the telescoping member is received by a sleeve and a pair of corresponding through-holes are provided in the member and the sleeve; wherein the telescoping member is positionable at a plurality of heights and supported at each height by a pin inserted through the respective through-holes.

7. The utility trailer of claim 1, wherein the means for pivoting the dump box comprises a hydraulic lift cylinder.

8. The utility trailer of claim 7, further comprising a control box positioned at the front of the frame, the control box arranged to allow for manual control of the hydraulic lift cylinder.

9. The utility trailer of claim 1, further comprising a ramp positioned at the rear end and moveable between a lowered position and a raised position; the ramp comprising a retention spring for biasing the ramp into the raised position.

10. The utility trailer of claim 9, further comprising a locking mechanism for locking the ramp in the raised position.

11. A multi-purpose utility trailer for transporting materials and equipment, the utility trailer comprising:
a wheeled elongated frame having front and rear ends and opposing elongated side members;
a platform positioned at the rear end of the frame for supporting and transporting equipment;
a dump box positioned at the front end of the frame; the dump box pivotably coupled to the frame and moveable between a lowered position for containing and transporting materials and a raised position for discharging materials to one side of the frame;
means for pivoting the dump box between the lowered and raised positions;
the dump box comprising a plurality of side portions and a bottom portion, one of the side portions being pivotably attached to the dump box and pivotable between a closed position to retain the materials in the dump box and an open position to allow for discharge of the materials to the one side of the frame; and
a plurality of supporting stands positioned at the front end of the frame and selectably extendable from a retracted, raised position to an extended, lowered position, the supporting stands providing support to the frame when extended into the lowered position.
